(19) United States
(12) Patent Application Publication
(10) Pub. No.: US 2012/0199096 A1
(43) Pub. Date: Aug. 9, 2012

(54) COVER MEMBER FASTENING METHOD AND FASTENING STRUCTURE FOR A HEAD COVER

(75) Inventors: Shohei Mikami, Saitama (JP); Naoto Hirayama, Saitama (JP); Yasuhiro Hisano, Saitama (JP)

(73) Assignee: Honda Motor Co., Ltd., Tokyo (JP)

(21) Appl. No.: 13/501,704

(22) PCT Filed: Oct. 12, 2010
(86) PCT No.: PCT/JP2010/067862

§ 371 Date: Apr. 12, 2012

(30) Foreign Application Priority Data
Oct. 13, 2009 (JP) 2009-236023

(51) Int. Cl. F02F 7/00; B21K 3/00

(52) U.S. Cl. 123/195 C; 29/888.01

(57) ABSTRACT

A cover member fastening method and fastening structure are provided which can surly fasten and fix an abutting portion needing firm abutment and fixing and suppress a deformation of the cover member while suppressing a transmission of vibration to the cover member by further reducing the contact area with an engine body. In a fastening structure for a head cover (2) fastened to a cylinder head (1) by a fastening member (7) so as to cover the upper face of the cylinder head (1), an abutting portion (27) that abuts the upper face of the cylinder head (1) is formed on the internal face of the head cover (2). The lower face of a head-cover-side fastening boss (26) protrudes beyond the lower face of a head-cover-side attaching flange (22). An area A of the lower face of the head-cover-side fastening boss (26) is equal to or close to a minimum abutting area Amin obtained by dividing a necessary fastening axial force N of the fastening member (7) by an allowable stress σa defined by the material of the head cover (2).

### TECHNICAL FIELD

The present invention relates to a cover member fastening method and a head cover fastening structure for an internal combustion engine.

### BACKGROUND ART

Conventionally known sealing structures for the head cover of an internal combustion engine are a sealing structure using a liquid sealant and a sealing structure using a rubber gasket. From the standpoint of suppressing undesired sound originating from a transmission of vibration from a cylinder head to a head cover, it is preferable to use a rubber gasket having a superior undesired sound suppressing effect than the liquid sealant to employ a structure of holding the head cover in a floating condition.

However, such a floating structure by the rubber gasket is improper when there is an abutting part for further firm abutment and fixing between the head cover and the upper face of the cylinder head. Conversely, the sealing structure by a liquid sealant is suitable for fastening of the abutting part but is poor for suppressing undesired sound in comparison with the rubber gasket and has a difficulty of maintaining the sealed face uniform for a member like the head cover which is detached at the time of maintenance and which needs peeling and re-application of the sealant. Hence, it is difficult to strictly regulate the void space with the abutting part.

Accordingly, for example, Patent Literature 1 discloses a structure which is formed by an abutting part where a cylinder head and a rocker cover abut a rocker cover lower end edge that corresponds to a head cover attaching flange of the present invention, and a sealed part having a sealing member sandwiched between the cylinder head and the rocker cover. An elastic member intervenes between an intake manifold formed inside the head cover and the wall of a rocker arm room, and the bottom of the wall is recessed to address the unsteadiness of sealing, thereby having double seal lines. According to such a structure, the abutting part enables easy setting of the level of the compression of the sealing member, and reduces the abutting portion between the cylinder head and the head cover to improve the sound insulation, and a space between the intake manifold inside the head cover and the rocker arm room can be sealed.

### PRIOR ART DOCUMENT

### Patent Literatures

Patent Literature 1: JP 2004-138196 A

Patent Literature 2: JP 2000-104891 A

### DISCLOSURE OF INVENTION

### Problem to be Solved by the Invention

According to the structure of Patent Literature 1, however, the sealing between the intake manifold and a wall 2d of the rocker arm room is designed for an application which needs no firm abutment and fixing, and thus this structure cannot be applied to a head cover with an abutting part needing further firm abutment and fixing.

For example, in the case of a head cover formed together with a cam shaft holder for holding a cam shaft, when rubber gasket is used for a cam journal, it is difficult to maintain the circularity of the cam journal, resulting in undesired sound due to a partial worn-out of the cam shaft and a contact with the journal. Moreover, even if the liquid sealant is used for the cam journal, it is difficult to make the thickness of the liquid sealant uniform, and thus it is also difficult to strictly maintain the circularity of the cam journal. Hence, this structure cannot allow sufficient abutment and fixing of the cam journal.

Accordingly, an abutting part needing firm abutment and fixing requires a structure which accomplishes direct and firm fastening using a fastening member without a sealing member and which can reduce undesired sound.

Moreover, when fastening force necessary for firmly fastening the abutting part is applied, portions around the fastened part of the head cover may be distorted.

Patent Literature 2 discloses a structure for a cylinder head cover that has a gasket compressed between a cover side peripheral wall and a head side peripheral wall and a resin coating applied to the lower face of the boss for fastening a bolt to reduce generation of undesired sound. A protrusion level from the lower face of the cover side peripheral wall is changed depending on the level of the assembling distortion produced at a contact part between the cover peripheral wall and the boss for fastening the bolt.

According to the structure of Patent Literature 2, fastening and fixing are enabled by strongly pressing the boss for fastening the bolt against the head cover without making the area of the bolt fastening boss increased, but a space by what corresponds to the abutment is necessary between the head cover lower face and the head upper face. Accordingly, this structure cannot be applied to a head cover which needs not only fastening of the head cover but also abutment and fixing of the abutting part. Hence, in order to apply necessary fastening force while suppressing any negative effect to the head cover, it is necessary to increase the diameter of the fastening boss and to make the head cover thick.

The present invention has been made in view of the above-explained circumstances, and it is an object of the present invention to provide a cover member fastening method and a head cover fastening structure which allows fastening of an abutting part with sufficient fastening force while suppressing a transmission of vibration to a head cover.

### Means for Solving the Problem

The present invention provides a fastening method for a cover member, the cover member including an abutting portion which is formed in the cover member, fastened to an engine body by a fastening member inserted in a fastening boss formed continuously from a peripheral edge of the cover member and pressed against and fixed to the engine body at predetermined pressure by fastening force by the fastening member, the method including: calculating fastening axial force by the fastening member necessary for fixing of the abutting portion; calculating an abutting area in accordance with allowable stress of a material of the cover member based on a relationship between stress to the fastening axial force and an abutting area; and setting an area of the fastening boss as a minimum area that is the calculated abutting area.

According to the fastening method employing such a structure, by obtaining fastening axial force necessary for fastening the abutting portion that needs firm fixing in an abutting manner, calculating the abutting area corresponding to the necessary fastening axial force based on the relationship between the stress of the cover member and the abutting area, setting this area as the minimum fastening boss area and designing the boss area so as not to be smaller than such a minimum area, the abutting portion can be firmly fixed in an abutting manner without causing the cover member being deformed, and the contact area of the cover member with the engine body is reduced, thereby reducing the vibration noises of the cover member.

Moreover, by applying this method, designing that ensures the area of the fastening boss necessary for each abutting portion is enabled from the beginning of the designing, and thus the reliability is improved.

Moreover, the present invention also provides a fastening structure for a head cover, the head cover covering a cylinder head through a head-cover-side attaching flange formed at a peripheral edge of the head cover, fastened to the cylinder head by a fastening member inserted in a head-cover-side fastening boss, and including an upper cam shaft receiving portion formed together with the head cover inside the head cover, a minimum area of the head-cover-side fastening boss fastened with the fastening member being set to be a minimum abutting area Amin that is obtained by dividing fastening axial force N necessary for fastening the upper cam shaft receiving portion by allowable stress σa defined by a material of the head cover.

According to such a structure, even if the fastening force necessary for firmly fastening the upper cam shaft receiving portion formed together with the head cover with a lower can shaft receiving portion is applied to the head cover fastening member, no head cover is deformed, and a fastening boss with a small abutting area can be configured. Hence, an appropriate abutting area between the head cover and the head can be obtained to reduce the transmission of vibration, thereby providing the head cover with a good reliability.

It is preferable that a predetermined space should be provided between a lower face of the head-cover-side attaching flange and an upper face of the cylinder head, the head-cover-side attaching flange should be formed with a recess groove opened toward the cylinder head, and a sealing member fitted in the recess groove should seal the space between the cylinder head and the head cover.

According to such a structure, a fastening structure is obtained which enables fastening at the head-cover-side attaching flange that does not need relatively large fastening force via the elastic sealing member like a rubber gasket. Hence, transmission of vibration to the head cover is suppressed to reduce undesired sound. Moreover, by setting the area of the fastening boss of the fastening member that applies the fastening axial force satisfying the fastening at the cam shaft receiving portion needing a firm fastening as the minimum abutting area, transmission of vibration from the abutting portion is minimized, and thus undesired sound can be further reduced.

It is further preferable that the upper cam shaft receiving portion and the head-cover-side attaching flange should be continuous from each other, the head-cover-side fastening boss should be provided between the upper cam shaft receiving portion and the head-cover-side attaching flange, and the head-cover-side fastening boss should be caused to have an area equal to or close to the minimum abutting area by a non-contact portion formed between the head-cover-side fastening boss and the head-cover-side attaching flange.

According to such a structure, in comparison with a head cover structure that accomplishes fastening only by a head-cover-side fastening boss provided around the outer periphery of a head-cover-side attaching flange surface, the fastening boss is provided near the portion continuous from the cam shaft receiving portion needing firm fastening, and a wall structure having the head-cover-side attaching flange surface and the cam shaft receiving portion continuous from each other. Hence, the fastening axial force necessary for fastening the earn shaft receiving portion can be reduced, which enables setting of the area of the fastening boss to be small. Moreover, the fastening bolt boss is located inwardly of the head-cover-side attaching flange, making the head cover itself compact. In addition, further adjustment of the head-cover-side fastening boss to the minimum abutting area is facilitated by a non-contact portion.

### Effect of the Invention

According to the present invention, a cover member fastening method can be provided which can fasten an abutting portion with sufficient fastening force while suppressing a transmission of vibration to a head cover.

Moreover, according to the present invention, a head cover fastening structure can be provided which allows setting of an abutting area of a fastening boss to an area equal to or close to a minimum abutting area while maintaining sufficient necessary fastening force to the abutting portion formed in the head cover and needing firm abutment and fixing with the upper face of a cylinder head, etc., in an abutting manner to reduce the contact area, thereby reducing a transmission of vibration, and which further suppresses a transmission of vibration to the head cover by providing an elastic member at a head cover attaching flange at the peripheral edge of the head cover.

### BRIEF DESCRIPTION OF DRAWINGS

FIG. 1 is a schematic top view of a cylinder head;

FIG. 2 is a cross sectional view of a cylinder head and a head cover taken along a line I-I in FIG. 1;

FIG. 3 is a perspective view showing a head cover gazed up from the bottom;

FIG. 4A is a partial enlarged view of FIG. 2; and

FIG. 4B is a diagram taken along a line II-II in FIG. 4A.

### BEST MODE FOR CARRYING OUT THE INVENTION

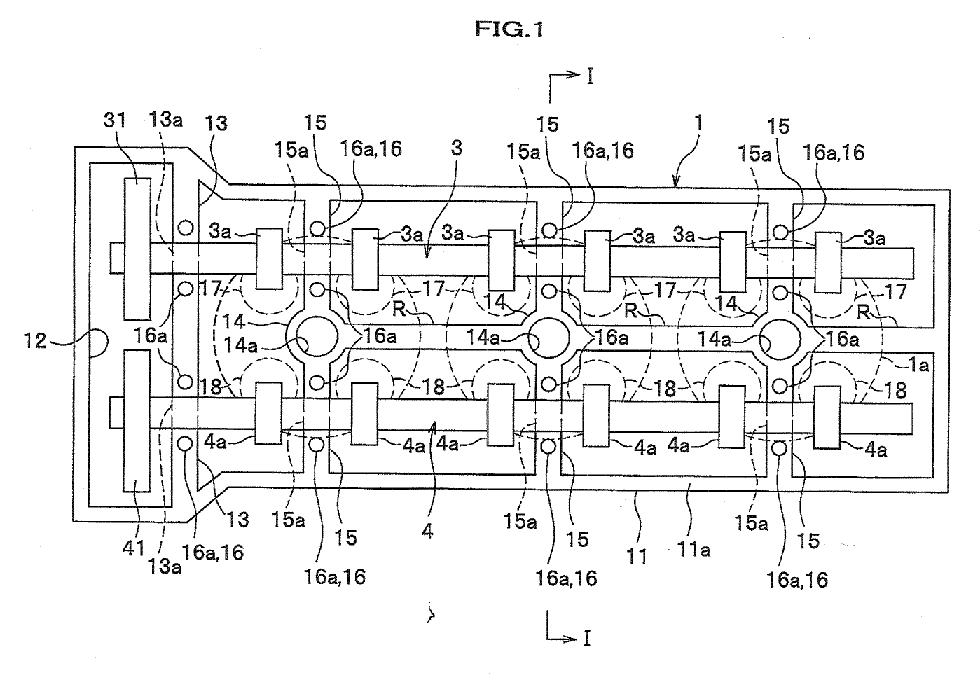

A detailed explanation will be given of an embodiment of the present invention with reference to the accompanying drawings. In the following explanation, the same structural element will be denoted by the same reference numeral, and the duplicated explanation thereof will be omitted. When a direction is indicated in the following explanation, the direction of the axial lines of cam shafts 3 and 4 shown in FIG. 1 is defined as a lengthwise direction, and a direction orthogonal to the axial line is defined a short direction. Moreover, the explanation will be given with a definition that the direction of the axial line of a combustion chamber 1a shown in FIG. 1 (a direction orthogonal to the paper face) is a vertical direction.

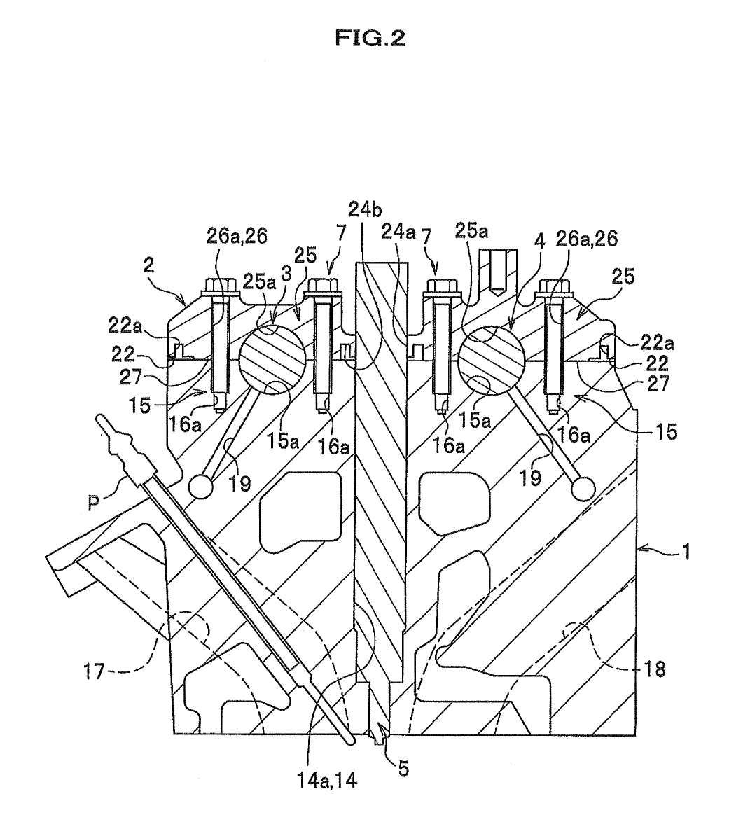

As shown in FIGS. 1 and 2, a cylinder head 1 is a part of an in-line three piston engine, and holds an intake cam shaft 3 and an exhaust cam shaft 4 in a rotatable manner. Provided around the cylinder head 1 is an outer periphery wall 11 as a rectangular frame, and a cylinder-head-side attaching face 11a for attaching a head cover 2 (see FIG. 2) to be discussed later is formed on the top end face of the outer periphery wall 11.

A cam chain room 12 that retains a timing chain (unillustrated) and cam sprockets 31 and 41 are formed at an end space of the cylinder head 1. A lower cam shaft holder 13 as a wall that holds respective one end sides of the intake cam shaft 3 and the exhaust cam shaft 4 is formed adjacent to the earn chain room 12 and together with the cylinder head 1.

The cylinder head 1 has injector placing portions 14 which are for placing injectors 5 (see FIG. 2) that inject fuels to respective combustion chambers 1a and which are formed between the intake cam shaft 3 and the exhaust cam shaft 4. According to this embodiment, three injector placing portions 14 corresponding to the three combustion chambers 1a are formed. Each injector placing portion 14 is formed in a cylindrical shape and has a placing hole 14a at the center thereof.

The adjoining injector placing portions 14 are coupled together via a reinforcement rib R.

Lower cam shaft holders 15, 15, and 15 that are walls supporting the intake cam shaft 3 and the exhaust cam shaft 4, respectively, are provided at both ends of each injector placing portion 14 (more specifically, both ends in the direction orthogonal to the cam shafts 3 and 4). Respective both ends of the three lower cam shaft holders 15 are continuous the outer periphery wall 11 and the injector placing portions 14.

The lower cam shaft holders 13 and 15 have respective journals 13a and 15a (see FIG. 2) each of which is a semi-circular recess for supporting the intake cam shaft 3 or the exhaust cam shaft 4 in a rotatable manner. Moreover, each of the lower cam shaft holders 13 and 15 has fastening holes 16a and 16a each engaged with a fastening member 7 like a bolt at both ends of the journals 13a and 15a in order to fasten the head cover 2 to the cylinder head 1. That is, the portions of the lower cam shaft holders 13 and 15 in the upper faces thereof around the fastening holes 16a configure cylinder-head-side fastening bosses 16.

The cylinder-head-side attaching face 11a that is an upper face of the outer periphery wall 11, respective upper faces of the lower cam shaft holders 13 and 15, respective upper faces of the injector placing portions 14, and respective upper faces of the reinforcement ribs R are leveled and flat.

Moreover, provided around each injector placing portion 14 are two intake ports 17, 17 opened to the combustion chamber 1a and two exhaust ports 18, 18, respectively.

Furthermore, the intake cam shaft 3 has an intake cam 3a located at a position corresponding to each intake port 17, and the exhaust cam shaft 4 has an exhaust cam 4a located at a position corresponding to each exhaust port 18.

As shown in FIG. 2, the cylinder head 1 has an oil passage 19 for supplying an oil to the journal 15a of the lower cam shaft holder 15. Moreover, the cylinder head 1 has a glow plug P disposed obliquely.

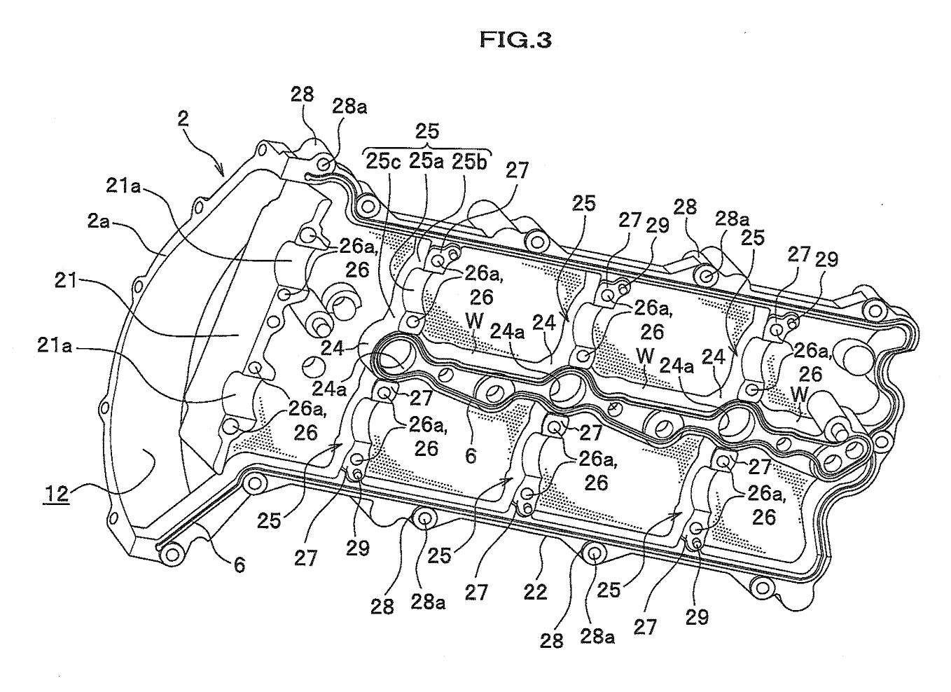

FIG. 3 is a perspective view showing the head cover gazed up from the bottom.

As shown in FIG. 3, the head cover 2 is a part covering the top of the cylinder head 1, and is formed in a substantially rectangular shape in a planar view. One end side 2a of the head cover 2 has a width widespread to cover the upper part of the cam chain room 12 (see FIG. 1) that retains the timing chain, etc., thereinside.

The head cover 2 has an upper cam shaft holder 21 that is a wall adjacent to the cam chain room 12 and holding respective one ends of the intake cam shaft 3 and the exhaust cam shaft 4. The upper cam shaft holder 21 is extended in a direction orthogonal to the axial directions of the cam shafts 3 and 4 (see FIG. 1), and is formed together with the head cover 2.

A head-cover-side attaching flange 22 that is a wall extending downwardly is successively formed at the periphery of the head cover 2 other than the one end side 2a. A successive recess groove 22a (see FIG. 2) in the lengthwise direction is formed in the lower face of the head-cover-side attaching flange 22. The recess groove 22a is provided with a sealing member 6 formed of an elastic material. The drawing in FIG. 2 has the sealing member 6 in the recess groove 22a omitted.

Three through holes 24a to be communicated with the placing holes 14a, respectively, of the injector placing portions 14 of the cylinder head 1 are formed at the center of the head cover 2 in a line at an equal interval in the lengthwise direction. A cylindrical wall 24 extending downwardly is formed around the through hole 24a.

The adjoining cylindrical walls 24 are coupled together through a reinforcement wall W extending downwardly from the inner face of the head cover 2. The lower face of the cylindrical wall 24 and the lower face of the reinforcement wall W are leveled and flat, and an annular recess groove 24b (see FIG. 2) is formed along respective outer peripheries of both walls. The sealing member 6 is fitted in the recess groove 24b. The drawing of FIG. 2 has the sealing member 6 in the recess groove 24b omitted.

Upper cam shaft holders 25, 25, 25, etc., which are walls holding the intake cam shaft 3 and the exhaust cam shaft 4, respectively, at both sides of the cylindrical wall 24 (more specifically, at both sides in a direction orthogonal to the cam shafts 3 and 4). Both ends of the upper cam shaft holder 25 are continuous from the head-cover-side attaching flange 22 and the cylindrical wall 24, respectively.

The upper cam shaft holders 21 and 25 respectively have journals 21a and 25a (see FIG. 2) each of which is a semi-circular recess supporting the intake cam shaft 3 or the exhaust cam shaft 4 in a rotatable manner.

The explanation will be given of the upper cam shaft holder 25 in more detail, and the upper cam shaft holder 25 has a continuous portion 25b that couples the journal 25a and the head-cover-side attaching flange 22 together. Moreover, the upper cam shaft holder 25 has a continuous portion 25c that couples the journal 25a and the cylindrical wall 24 together.

Respective lower faces of the continuous portions 25b and 25c configure an abutting portion 27 that abuts respective upper faces of the lower cam shaft holders 13 and 15 provided at the cylinder head 1.

The continuous portions 25b and 25c of the upper cam shaft holder 25 are formed with insertion holes 26a, 26a for inserting respective fastening members 7 that fasten the head cover 2 to the cylinder head 1. Moreover, the insertion holes 26a, 26a for inserting respective fastening members 7 are also formed at both ends of the journal 21 of the upper cam shaft holder 21 adjacent to the cam chain room 12. The insertion holes 26a are formed at corresponding locations to the fastening holes 16a of the cylinder head 1.

Portions of the upper cam shaft holders 21 and 25 around the insertion holes 26a function as a head-cover-side fastening boss 26. According to this embodiment, the lower face of the head-cover-side fastening boss 26 and the abutting portion 27 partially overlap with each other, and both are continuous from each other in a leveled and flat manner.

According to this embodiment, a plurality of substantially cylindrical head-cover-side fastening bosses 28 are formed at the outer periphery of the head-cover-side attaching flange 22 at an equal interval. The head-cover-side fastening boss 28 has an insertion hole 28a for inserting the fastening member 7. The lower face of the head-cover-side fastening boss 28 protrudes from the lower face of the head-cover-side attaching flange 22.

It is not illustrated in the figures but cylinder-head-side fastening bosses corresponding to the head-cover-side fastening bosses 28 are formed at the outer periphery wall 11 of the cylinder head I, and both bosses can be fastened together.

Moreover, the continuous portion 25b of the upper cam shaft holder 25 is formed with a protrusion 29 for positioning the head cover 2 to the cylinder head 1. The protrusion 29 is to be fitted in an unillustrated recess formed in the upper face of the lower cam shaft holder 15 of the cylinder head 1.

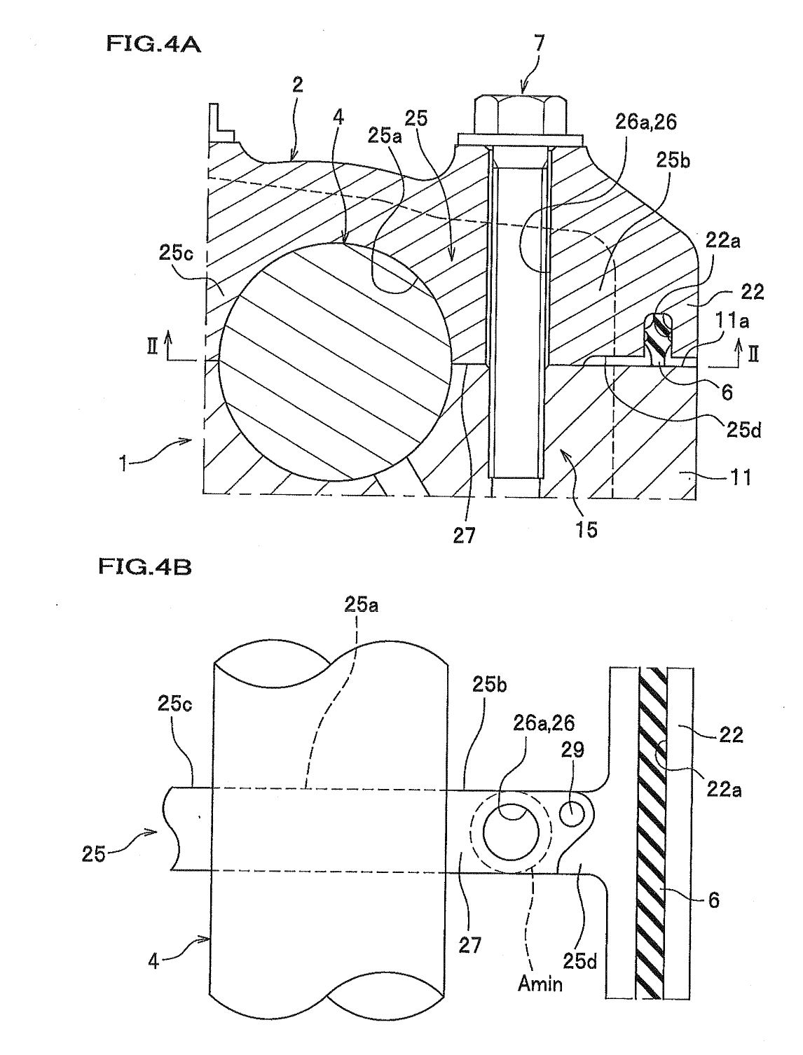

Next, with reference to FIG. 4, a detailed explanation will be given of the fastening of the cylinder head 1 with the head cover 2 with the lower cam shaft holder 15 and the upper cam shaft holder 25 taken as an example.

As shown in FIG. 4A, the lower face of the upper cam shaft holder 25 protrudes beyond the lower face of the head-cover-side attaching flange 22. In other words, with the lower face of the upper cam shaft holder 25 abutting the upper face of the lower cam shaft holder 15, the lower face of the head-cover-side attaching flange 22 is floating from the cylinder-head-side attaching face 11a of the cylinder head 1.

The sealing member 6 is fitted in the recess groove 22a formed in the lower face of the head-cover-side attaching flange 22.

The sealing member 6 is a so-called rubber gasket formed of an elastic material like nitrile rubber. The dimension in height of the sealing member 6 is larger than the dimension in depth of the recess groove 22a. The lower end of the sealing member 6 spreads out from the recess groove 22a, and contacts the cylinder-head-side attaching face 11a with pressure, thereby sealing a space between the cylinder-head-side attaching face 11a and the head-cover-side attaching flange 22.

The same is true of the sealing member 6 disposed between the lower face of the cylindrical wall 24 and the recess groove 24b formed in the lower face of the reinforcement wall W (see FIGS. 2 and 3).

As shown in FIGS. 4A and 4B, a notch 25d that is a non-contact portion is formed in the lower face of the continuous portion 25b of the upper can shaft holder 25 in such a way that the contact area with the lower cam shaft holder 15 becomes as close as possible to a minimum abutting area Amin or a minimum abutting area Amin corresponding to the necessary fastening axial force. According to this structure, by further reducing the contact area between the cylinder head 1 and the head cover 2, it becomes possible to reduce vibration transmitted to the head cover 2 from the cylinder head 1.

The minimum abutting area Amin can be easily obtained by dividing the necessary fastening axial force N (N) for the fastening member 7 by the allowable stress σa (N/mm²) defined by the material of the head cover 2. Hence, the notch 25d can be adjusted as needed so that an area A of the lower face of the continuous portion 25b of the upper cam shaft holder 25 (i.e., the lower face of the head-cover-side fastening boss 26) becomes equal to or close to the minimum abutting area Amin (mm²) or the minimum abutting area Amin. The area close to the minimum abutting area Amin according to the present invention means an area larger than the minimum abutting area Amin but is as close as possible to the minimum abutting area Amin within the restriction by the structure of the head cover 2. According to this structure, when the cylinder head 1 and the head cover 2 are fastened using the fastening members 7, it is possible to surely prevent the head-cover-side fastening bosses 26 from plastically deforming, and to suppress a transmission of vibration from the cylinder-head-side fastening bosses 16 to the head cover 2, thereby enabling sure and firm fastening and fixing of the journals 13a and 15a.

It is preferable that the area A of the lower face of the head-cover-side fastening boss 26 should be equal to or smaller than twice as much as the minimum abutting area Amin, and more preferably, equal to or smaller than 1.5 times as much as the minimum abutting area.

According to this structure, a transmission of vibration can be suppressed while addressing the restriction over the manufacturing of the cylinder head 1 and the head cover 2.

The necessary fastening axial force N for the fastening member 7 is a minimum axial force which does not allow the fastening member 7 to be loosen when driving the cams and the spaces between the lower cam shaft holders 13, 15 and the upper cam shaft holders 21, 25 to be opened, and can be obtained in advance for each fasting location through, for example, a test.

Moreover, the allowable stress σa defined by the material of the head cover 2 is stress which does not cause the head-cover-side fastening boss 26 to be plastically deformed by the fastening axial force by the fastening member 7, and is set based on, for example, unique elastic critical point and breaking point to the material of the head cover 2.

According to this embodiment, the lower face of the continuous portion 25c of the upper cam shaft holder 25, and the lower faces of the head-cover-side fastening bosses 28 formed at the outer periphery of the head-cover-side attaching flange 22 are also formed to have the same or similar area to the minimum abutting area Amin (mm²).

Next, an advantage of the fastening structure of the head cover 2 according to this embodiment will be explained.

According to the fastening structure of the head cover 2 of this embodiment, the sealing member 6 that abuts the cylinder-head-side attaching face 11a is disposed in the recess groove 22a provided in the lower face of the head-cover-side attaching flange 22, and the lower faces of the head-cover-side fastening bosses 26 protrude beyond the lower face of the head-cover-side attaching flange 22. Accordingly, a float supporting structure by the sealing member 6 which minimizes a transmission of vibration from the cylinder head 1 via the head-cover-side fastening bosses 26 can be realized.

Moreover, the area A of the lower face of the head-cover-side fastening boss 26 is equal to or close to the minimum abutting area Amin obtained by dividing the necessary fastening axial force N for the fastening member 7 by the allowable stress σa defined by the material of the head cover 2. Hence, even if the fastening member 7 is tightened by the necessary fastening axial force N, a compression stress σ to the head-cover-side fastening boss 26 does not exceed the allowable stress σa. Accordingly, the head-cover-side fastening boss 26 does not plastically deform.

Furthermore, according to this embodiment, the lower face of the head-cover-side fastening boss 26 is continuous from the abutting portion 27 in a leveled and flat manner (i.e., the lower faces of the continuous portions 25b and 25c of the upper cam shaft holder 25) is caused to have the area A that is equal to or close to the minimum abutting area Amin. Accordingly, it becomes possible to make a transmission of vibration as minimum as possible while surely maintaining the liquid-tight (oil-tight) condition of the abutting portion 27 with a smaller fastening axial force.

Still further, according to this embodiment, the abutting portion 27 is coupled together in leveled and flat manner with the lower faces of the head-cover-side fastening bosses 26 (in other words, the head-cover-side fastening bosses 26 are formed at the continuous portions 25b and 25c of the upper cam shaft holders 25 configuring the abutting portion 27). Hence, even if the sealing member 6 that is a rubber gasket is used, the lower cam shaft holders 13, 15 and the upper cam shaft holders 21, 25 can be rigidly fastened with each other, and both are firmly fixed in an abutting manner with an abutting condition, and thus the journals 13a, 15a, 21a, and 25a can be strictly managed to maintain respective circularities.

The embodiment of the present invention was explained in detail with reference to the accompanying drawings, but the present invention is not limited to the above-explained embodiment, and can be changed and modified as needed without departing from the scope and spirit of the present invention.

For example, according to the above-explained embodiment, the lower cam shaft holders 13 and 15 are formed together with the cylinder head 1, but the present invention is not limited to this form. The lower cam shaft holders 13 and 15 can be separate parts disposed on the upper face of the cylinder head 1. This structure can also accomplish the same advantages as those of the above-explained embodiment.

Moreover, according to the above-explained embodiment, the plurality of head-cover-side fastening bosses 28 each in a substantially cylindrical shape are formed at the outer periphery of the head-cover-side attaching flange 22 at an equal interval. It is more desirable that the head-cover-side fastening boss 28 should be located at the substantially middle portion of the cam shaft receiving portion as viewed from the direction of the cam shaft. According to this structure, the outer periphery of the head cover 2 can be surely sealed with less fastening means. Moreover, unlike the above-explained embodiment, the fastening structure may employ only head cover fastening bolt bosses continuous from the upper cam shaft holder. According to this structure, the head cover can be compact.

Furthermore, according to the above-explained embodiment, the fastening structure for the head cover 2 employs the upper cam shaft holders 21 and 25 formed together with the head cover, but the fastening method of the present invention is not limited to this kind of application. The present invention can also be applied to the fastening of a cover member having an abutting portion thereinside which needs firm abutment and fixing.

### DESCRIPTION OF REFERENCE NUMERALS

1 Cylinder head

1a Combustion chamber

11 Outer periphery wall

11a Cylinder-head-side attaching face

13, 15 Lower cam shaft holder

16 Cylinder-head-side fastening boss

16a Fastening hole

2 Head cover

21, 25 Upper cam shaft holder

22 Head-cover-side attaching flange

22a Recess groove

25b, 25c Continuous portion

26 Head-cover-side fastening boss

26a Insertion hole

27 Abutting portion

3 Intake cam shaft

4 Exhaust cam shaft

5 Injector

6 Sealing member

7 Fastening member

1. A fastening method for a cover member, the cover member including an abutting portion which is formed in the cover member, fastened to an engine body by a fastening member inserted in a fastening boss formed continuously from a peripheral edge of the cover member and pressed against and fixed to the engine body at predetermined pressure by fastening force by the fastening member, the method comprising:
calculating fastening axial force by the fastening member necessary for fixing of the abutting portion;
calculating an abutting area in accordance with allowable stress of a material of the cover member based on a relationship between stress to the fastening axial force and an abutting area; and
setting an area of the fastening boss as a minimum area that is the calculated abutting area.

2. A fastening structure for a head cover, the head cover covering a cylinder head through a head-cover-side attaching flange formed at a peripheral edge of the head cover, fastened to the cylinder head by a fastening member inserted in a head-cover-side fastening boss, and including an upper cam shaft receiving portion formed together with the head cover inside the head cover,
a minimum area of the head-cover-side fastening boss fastened with the fastening member being set to be a minimum abutting area that is obtained by dividing fastening axial force necessary for fastening the upper cam shaft receiving portion by allowable stress defined by a material of the head cover.

3. The head cover fastening structure according to claim 2, wherein
a predetermined space is provided between a lower face of the head-cover-side attaching flange and an upper face of the cylinder head,
the head-cover-side attaching flange is formed with a recess groove opened toward the cylinder head, and
a sealing member fitted in the recess groove seals the space between the cylinder head and the head cover.

4. The head cover fastening structure according to claim 2, wherein
the upper cam shaft receiving portion and the head-cover-side attaching flange are continuous from each other,
the head-cover-side fastening boss is provided between the upper cam shaft receiving portion and the head-cover-side attaching flange, and
the head-cover-side fastening boss is caused to have an area equal to or close to the minimum abutting area by a non-contact portion formed between the head-cover-side fastening boss and the head-cover-side attaching flange.

5. The head cover fastening structure according to claim 3, wherein
the upper cam shaft receiving portion and the head-cover-side attaching flange are continuous from each other,
the head-cover-side fastening boss is provided between the upper cam shaft receiving portion and the head-cover-side attaching flange, and
the head-cover-side fastening boss is caused to have an area equal to or close to the minimum abutting area by a non-contact portion formed between the head-cover-side fastening boss and the head-cover-side attaching flange.
